(19) United States
(12) Patent Application Publication
(10) Pub. No.: US 2026/0134549 A1
(43) Pub. Date: May 14, 2026

(54) INFORMATION PROCESSING APPARATUS

(71) Applicant: NEC Corporation, Tokyo (JP)

(72) Inventors: Shuhei Yoshida, Tokyo (JP); Takashi SHIBATA, Tokyo (JP); Makoto TERAO, Tokyo (JP)

(73) Assignee: NEC Corporation, Tokyo (JP)

(21) Appl. No.: 19/358,783

(22) Filed: Oct. 15, 2025

(30) Foreign Application Priority Data
Nov. 8, 2024 (JP) 2024-195719

(51) Int. Cl. G06T 7/20

(52) U.S. Cl. CPC G06T 7/20; G06T 2207/30241

(57) ABSTRACT

An information processing apparatus according to the present disclosure includes: a detecting unit that detects objects from images of respective times, and calculates reliability levels of the detected objects; a concatenating unit that sets concatenation information that concatenates between the objects detected for the respective times; a calculating unit that calculates a value of the concatenation information in accordance with the reliability levels of the objects concatenated by the concatenation information; and a setting unit that determines whether to adopt or reject the concatenation information that concatenates between the objects in accordance with the value of the concatenation information, and sets the concatenation between the objects by the adopted concatenation information, as an object trajectory.

### INCORPORATION BY REFERENCE

This application is based upon and claims the benefit of priority from Japanese patent application No. 2024-195719, filed on Nov. 8, 2024, the disclosure of which is incorporated herein in its entirety by reference.

### TECHNICAL FIELD

The present disclosure relates to an information processing apparatus.

### BACKGROUND ART

Tracking of a moving object such as a person using captured images is being performed. For example, Patent Literature 1 describes tracking a person or a moving machine in images captured by a camera and grasping the activity of the person or the moving machine in a workplace or a facility.

### CITATION LIST

### Patent Literature

Patent Literature 1: Japanese Unexamined Patent Application Publication No. JP-A 2020-098590

### SUMMARY OF INVENTION

### Technical Problem

However, in tracking a moving object in images, there arises a problem that the accuracy of tracking lowers due to an image capturing environment. For example, the accuracy of tracking a moving object lowers due to an image capturing environment such as image distortion or a moving object to be tracked being obscured by another object.

Accordingly, an object of the present disclosure is to solve the abovementioned problem that the accuracy of tracking a moving object in images lowers.

### Solution to Problem

An information processing apparatus as an aspect of the present disclosure includes: a detecting unit configured to detect objects from images of respective times, and calculate reliability levels of the detected objects; a concatenating unit configured to set concatenation information that concatenates between the objects detected for the respective times; a calculating unit configured to calculate a value of the concatenation information in accordance with the reliability levels of the objects concatenated by the concatenation information; and a setting unit configured to determine whether to adopt or reject the concatenation information that concatenates between the objects in accordance with the value of the concatenation information, and set the concatenation between the objects by the adopted concatenation information, as an object trajectory.

Further, an information processing method as an aspect of the present disclosure includes: detecting objects from images of respective times, and calculating reliability levels of the detected objects; setting concatenation information that concatenates between the objects detected for the respective times; calculating a value of the concatenation information in accordance with the reliability levels of the objects concatenated by the concatenation information; and determining whether to adopt or reject the concatenation information that concatenates between the objects in accordance with the value of the concatenation information, and setting the concatenation between the objects by the adopted concatenation information, as an object trajectory.

Further, a program as an aspect oof the present disclosure includes instructions for causing an information processing apparatus to detect objects from images of respective times, and calculate reliability levels of the detected objects; set concatenation information that concatenates between the objects detected for the respective times; calculate a value of the concatenation information in accordance with the reliability levels of the objects concatenated by the concatenation information; and determine whether to adopt or reject the concatenation information that concatenates between the objects in accordance with the value of the concatenation information, and set the concatenation between the objects by the adopted concatenation information, as an object trajectory.

### Advantageous Effects of Invention

Configured as described above, the present disclosure can achieve increase of the accuracy of tracking a moving object in images.

### BRIEF DESCRIPTION OF DRAWINGS

FIG. 1 is a block diagram showing an example of a configuration of an information processing apparatus according to the present disclosure;

FIG. 2 is a diagram showing an example of a state of processing by the information processing apparatus according to the present disclosure;

FIG. 3 is a diagram showing an example of a state of processing by the information processing apparatus according to the present disclosure;

FIG. 4 is a flowchart showing an example of processing operation of the information processing apparatus according to the present disclosure;

FIG. 5 is a block diagram showing an example of a hardware configuration of an information processing apparatus according to the present disclosure; and

FIG. 6 is a block diagram showing an example of a configuration of the information processing apparatus according to the present disclosure.

### EXAMPLE EMBODIMENT

### First Example Embodiment

A first example embodiment of the present disclosure will be described with reference to the drawings. The drawings may be related to any of the example embodiments.

An information processing apparatus according to the present disclosure is used for tracking a moving object such as a person appearing in an image, using the image. As an example, the present disclosure is used for tracking a worker and to recognize or record a work activity at a worksite such as a factory. However, a moving object to be tracked in the present disclosure is not limited to a person and may be any object such as a work robot or an animal.

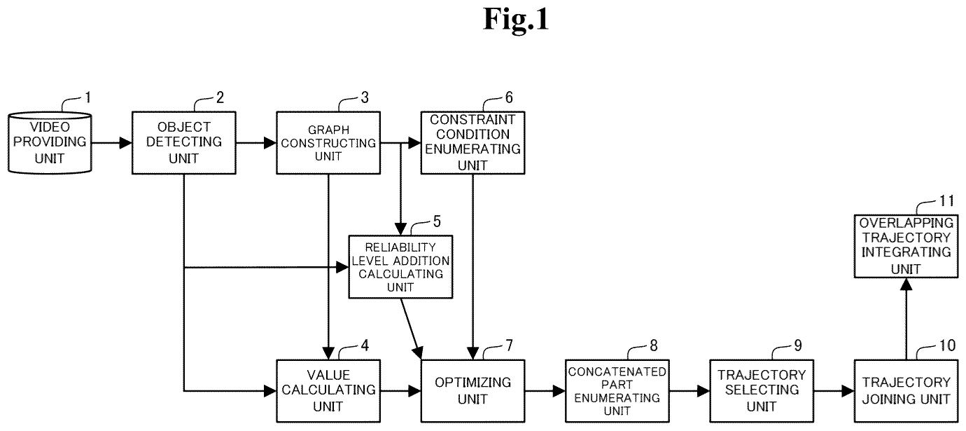

The information processing apparatus is configured with one or a plurality of information processing apparatuses each including an arithmetic logic unit and a memory unit. As illustrated in FIG. 1, the information processing apparatus includes a video providing unit 1, an object detecting unit 2, a graph constructing unit 3, a value calculating unit 4, a reliability level addition calculating unit 5, a constraint condition enumerating unit 6, an optimizing unit 7, a concatenated part enumerating unit 8, a trajectory selecting unit 9, a trajectory joining unit 10, and an overlapping trajectory integrating unit 11. The video providing unit 1 is configured with the memory unit. The respective functions of the object detecting unit 2, the graph constructing unit 3, the value calculating unit 4, the reliability level addition calculating unit 5, the constraint condition enumerating unit 6, the optimizing unit 7, the concatenated part enumerating unit 8, the trajectory selecting unit 9, the trajectory joining unit 10, and the overlapping trajectory integrating unit 11 can be realized by execution of a program for realizing the respective functions stored in the memory unit by the arithmetic logic unit. The respective components and operations will be described in detail below.

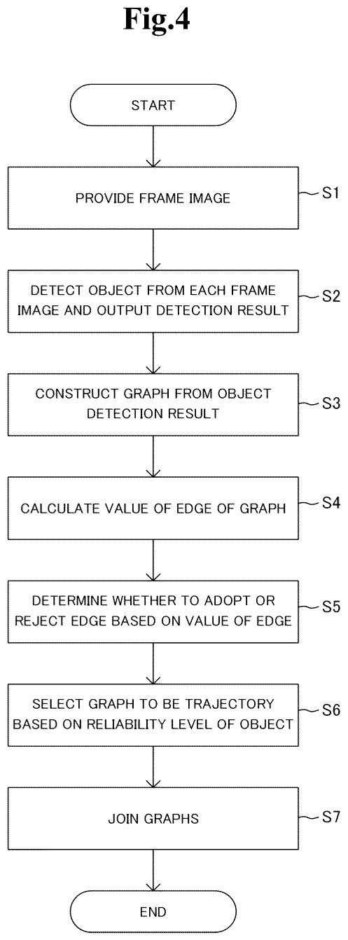

The video providing unit 1 provides image data captured by an imaging device at a shooting location such as a worksite, to the object detecting unit 2 (step S1 in FIG. 4). The image data includes the time series of frame images captured at time intervals.

The object detecting unit 2 (detecting unit) detects objects appearing in the frame images captured at the time intervals, and, for each of the objects detected from the frame images, outputs a detection result including coordinates, object class, reliability level of detection, and a feature value (coordinate, object class, reliability level, feature value) (step S2 in FIG. 4). At this time, the coordinates are, for example, real number values representing the position and size of a bounding box (e.g., the pixel coordinates of the center and the width and height, or the coordinates of the upper-left and lower-right vertices of the bounding box). Further, the object class is, for example, the type of an object, such as person or moving machine. Further, the reliability level of detection is, for example, the confidence level of the detection result, and as an example, is a confidence level that the detected object is an object or a confidence level that the detected object belongs to the detected object class. At this time, the reliability level is, for example, a real number between 0 and 1, and the closer to 1 the value is, the higher the reliability level of the detection result is. Further, the feature value is, for example, a fixed-dimensional vector calculated from the coordinates, the object class, and the pixel value of a frame image region indicated by the coordinates. As an example, the feature value may be a feature value vector obtained by processing a patch extracted from the object rectangle region of the frame image, using a convolutional neural network. Moreover, as an example, the feature value may be a feature value vector obtained by processing a 0/1 vector representing coordinates and object class through a multilayer perceptron. Moreover, as an example, the feature value may be a feature value vector obtained as a result of merging, such as concatenating or summing, the results of the aforementioned two examples. It should be noted that the specific examples of detection results (coordinates, object class, reliability level, feature value) described above are merely illustrative, and the information for object detected from the frame image may be any kind of information.

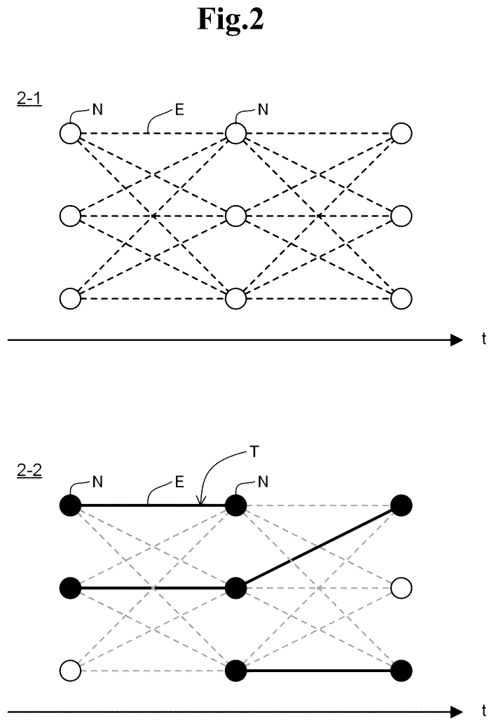

The graph constructing unit 3 (concatenating unit) constructs a graph obtained by concatenating objects detected from the frame images as described above, using concatenation information (step S3 in FIG. 4). Specifically, the graph constructing unit 3 constructs a graph in which each object, which is a detection result included within a predetermined time window, serves as a vertex and an edge representing concatenation information is established between a pair of vertices that may correspond to the same object and may be temporally adjacent on the trajectory of the object. For example, as shown in FIG. 2(2-1), a graph is constructed in which a vertex corresponding to an object (detection result) detected from a frame image captured at each time is set as a node N and an edge concatenating temporally adjacent objects is set as an edge E.

In the process of setting the edge E by the graph constructing unit 3, the aforementioned expression “temporally adjacent on the trajectory” is interpreted such that even on the trajectory with a gap (e.g., a case where the object has temporarily hidden behind an obstacle), detections immediately before and after the gap are also regarded as “adjacent”. As one example, a pair of objects that are separated by a certain temporal interval or less may be regarded as potentially adjacent, or a pair of objects whose degree of similarity in feature value exceeds a predetermined degree may be regarded as potentially adjacent, or a pair of objects whose difference in coordinates is a certain value or less may be regarded as potentially adjacent. Alternatively, instead of performing the threshold processing on the above three criteria or their combinations, it is acceptable to consider that the k nearest neighbors measured according to the aforementioned criteria for objects may be adjacent.

The aforementioned method for constructing a graph by the graph constructing unit 3, that is, the method of constructing a graph in which the nodes N corresponding to objects detected from the respective frame images are concatenated by the edge E, is not limited to the method described above, and may be accomplished by other methods for constructing the graph.

The value calculating unit 4 (calculating unit) calculates the value of each edge E from the graph constructed as described above (step S4 in FIG. 4). At this time, the value calculating unit 4 calculates the value of the edge E based on the detection results of the objects corresponding to the nodes N concatenated to both the ends of the edge E. For example, the value calculating unit 4 calculates the value of the edge E based on the similarity of the feature values of the objects corresponding to the nodes N concatenated to both the ends of the edge E. As one example, the value calculating unit 4 calculates a higher value as the similarity of the feature values of the objects is greater. The value calculating unit 4 may calculate the value of the edge E by any method and using any information and, as an example, may input detection results such as the feature values of the objects corresponding to the nodes N concatenated to the edge E, into a previously machine-learned neural network, and use the output as the value.

The reliability level addition calculating unit 5 (calculating unit) further calculates a value to be added to the value of each edge E, from the graph constructed as described above (step S4 in FIG. 4). In particular, the reliability level addition calculating unit 5 calculates a value to be added to the edge E, based on the reliability levels of the objects corresponding to the nodes N concatenated to both the ends of the edge E. For example, the reliability level addition calculating unit 5 first examines whether the reliability levels of the two nodes N concatenated to both the ends of the edge E, that is, the two objects, are equal to or greater than a preset threshold value. Then, the value calculating unit 4 examines which of the following three stages corresponds to the reliability levels of the two object: both are equal to or greater than the threshold, only one is equal to or greater than the threshold value, or both are below the threshold value. Then, the value calculating unit 4 calculates a value corresponding to each stage. At this time, as an example, the calculation is performed such that higher values correspond sequentially to both the objects having reliability levels equal to or greater than the threshold value, only one of the objects having a reliability level equal to or greater than the threshold value, and both being below the threshold value, and such that the reliability levels of the concatenated objects being higher results in a higher value. A value to be added may, for example, be set to a large magnitude such as 1,000 or 100,000 when the reliability levels of the two objects are both equal to or greater than the threshold value or when only one of them is equal to or greater than the threshold value, and as described above, it is set to a value greater than the value of the edge E calculated by the value calculating unit 4. The method for calculating a value to be added to the edge E described above is merely an example, and the value may be calculated by other methods. As an example, a constant multiple (e.g., 1,000) of the result obtained by applying a temperature-scaled sigmoid function to the difference between the sum of the reliability levels of the two objects concatenated to the edge E and twice the threshold value may be calculated as a value to be added.

As described above, the edge E of each graph is associated with a value calculated by the value calculating unit 4 plus a value based on the reliability level calculated by the reliability level addition calculating unit 5. At this time, since the value based on the reliability level is calculated with a greater weight, the edge E concatenated with the nodes N of the objects with higher reliability levels are associated with a higher value.

The constraint condition enumerating unit 6 enumerates constraint conditions that must be satisfied by a graph representing the set of trajectories. For example, the constraint conditions include: “each node N corresponding to an object representing a detection is connectable to at most one detection at time before that detection”, and “each node N corresponding to an object representing a detection is connectable to at most one detection at time after that detection”. However, other conditions may also be enumerated as the constraint conditions.

The optimizing unit 7 (setting unit) determines whether to adopt or reject (adoption or rejection) the edge E of the graph based on the value of the edge E (step S5 of FIG. 4). Specifically, the optimizing unit 7 preferentially adopts, among graphs satisfying the constraint conditions described above, a graph in which the value of the edge E is high. For example, the optimizing unit 7 may adopt the edge E whose value is equal to or greater than a predetermined threshold value, or whose value is ranked equal to or higher than a predetermined position. Consequently, the edge E for which a high value has been calculated due to the high reliability level of the object concatenated to the edge E is preferentially adopted. At this time, for example, when the value is calculated to be high due to the reliability level of only one of the objects concatenated to the edge E being equal to or greater than the threshold value, such an edge E may be adopted. In other words, even when only one of the objects concatenated to the edge E has a reliability level equal to or greater than the threshold value, and the other object has a reliability level below the threshold value, such an edge E may be adopted.

The process of adopting or rejecting the edge E by the optimizing unit 7 can also be expressed in the following manner. The optimizing unit 7 calculates, among the graphs satisfying all the constraint conditions, a graph in which the total of the values of the edges E is maximum. At this time, when a 0/1 variable x; indicating whether or not to adopt an edge Ei is assigned to the edge E; and the value of the edge is vᵢ, it becomes an integer linear programming problem in which Σᵢvᵢxᵢ is maximized under the constraint conditions. Due to the unimodularity of the constraint conditions, it is guaranteed that the problem can be solved as a (continuous) linear programming problem without any issues, and therefore, in practice, a linear programming solver can be used.

The optimizing unit 7 determines adoption or rejection of the edge E as described above and outputs the graph having the adopted edge E to the concatenated part enumerating unit 8. As an example, the edges E indicated by solid lines in FIG. 2(2-2) are adopted, and a graph T consisting of black-circle nodes N and solid-line edges E is output.

The concatenated part enumerating unit 9 (setting unit) outputs a set in which the graphs output by the optimizing unit 8 are enumerated. At this time, the graph including the edges E adopted and output by the optimization unit 8 is regarded as part of the trajectory of the object corresponding to the node N.

The trajectory selecting unit 10 (setting unit) receives as input a trajectory, which is a graph output by the concatenated part enumerating unit 9, and, based on the reliability level of the objects corresponding to the nodes N constituting the graph, determines a graph to be discarded from the trajectory, thereby selecting a graph to be the trajectory (step S6 in FIG. 4). For example, the trajectory selecting unit 10 calculates a trajectory reliability level from the reliability levels of objects corresponding to concatenated nodes N for each graph input as a trajectory, and discards a graph with the trajectory reliability level being below a threshold value from the trajectory. At this time, the trajectory reliability level is the average value or the maximum value of the reliability levels of two objects corresponding to the nodes N concatenated to the graph. Consequently, after adopting the edge E to set the graph as a trajectory as described above, a graph with low reliability levels of the objects corresponding to the nodes N concatenated to the edge E is discarded from the trajectory. The trajectory selecting unit 10 may determine a graph to be discarded by another method based on the reliability levels of objects corresponding to the nodes N constituting a graph. Then, the trajectory selecting unit 10 discards the graph from the trajectory as described above, and outputs the remaining graphs as the trajectory.

The trajectory joining unit 10 (joining unit) joins a plurality of graphs left as the trajectories, thereby generating and outputting an object trajectory (joined trajectory) (step S7 of FIG. 4). To be specific, the trajectory joining unit 10 joins the graphs enumerated as the trajectories for different time windows, and outputs a long-term object trajectory. At this time, the trajectory joining unit 10 considers the results of processing two time windows with an overlap by a sliding window method, and when the overlap of the trajectories contained in the two time windows is substantial, treats them as a single trajectory and joins them. Since each time window contains a plurality of trajectories, the trajectory joining unit 10 joins them so as to maximize the sum of the overlaps of trajectory pairs through Hungarian matching.

The overlapping trajectory integrating unit 11 (joining unit) receives as input the set of object trajectories output by the trajectory joining unit 10, and integrates those that overlap significantly among the input object trajectories, and then outputs the result. Specifically, with respect to a part where object trajectories overlap at the same time, that is, a part where trajectories coexist at the same time, of a plurality of object trajectories, the overlapping trajectory integrating unit 11 adopts the part in one object trajectory and discards the part in the other object trajectory, thereby further connecting and integrating a plurality of object trajectories. At this time, the overlapping trajectory integrating unit 11 adopts a part in an object trajectory with a high object reliability level, discards a part in an object trajectory with a low reliability level, thereby further connecting and integrating a plurality of object trajectories.

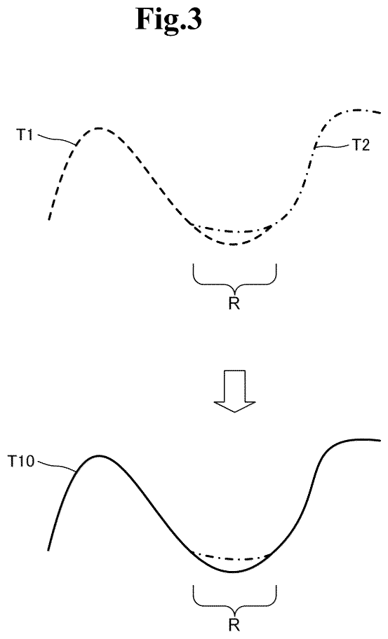

As an example, in the case illustrated in FIG. 3, first, there are two object trajectories T1 and T2, where the object trajectory T1 is indicated by a dotted line and the object trajectory T2 is indicated by a chain line, and the trajectories coexist at the same time R. In this case, the object reliability levels of the object trajectories T1 and T2 at the same time R are examined, and part of the object trajectory with a higher reliability level is adopted. As a result, in the case illustrated in FIG. 3, at the same time R, the part in the object trajectory T1 is adopted, the part in the object trajectory T2 (dash-dot line) is discarded, and they are further connected and integrated as indicated by a solid line as an object trajectory T10.

Here, a specific example of the processing performed by the overlapping trajectory integrating unit 11 will be described. The overlapping trajectory integrating unit 11 repeatedly executes the following steps 1 to 3.
1. The overlapping trajectory integrating unit 11 extracts, from an object trajectory set t output by the trajectory joining unit 10 as expressed by Formula 1, a pair of trajectories (Trajⱼ, Trajₖ) that satisfies an overlap condition and exhibits the greatest degree of overlap. If no pair satisfies the overlap condition, the iteration is terminated.

$$𝒯 = {\{ {Traj}_{j} = ( {obj}_{{t}_{j 1 ,} {i}_{j 2}} , {obj}_{{t}_{j 2} , {i}_{j 2}} , … , {obj}_{{t}_{j {L}_{j}} , {i}_{{jL}_{j}}} ) \}}_{j = 1}^{M} \qquad [ Formula 1 ]$$

An example of the overlap condition is that at least one frame in which Trajⱼ and Trajₖ overlap as expressed by Formula 1 exists, and furthermore, with respect to all frames in which Traⱼ and Trajₖ overlap expressed by Formula 3, the overlap between an object in frame t contained in Traⱼ; and an object in frame t contained in Trajₖ (measured by Intersection over Union (IoU) of bounding box) is greater than a threshold value θ₁, and furthermore, the ratio of frames in which the IoU is equal to or greater than a threshold value θₕ to the frames in which Trajⱼ and Trajₖ overlap is equal to or greater than θᵣ.

$$\{ {t}_{j 1} , {t}_{j 2} , … , {t}_{j {L}_{j}} , \} ⋂ \{ {t}_{k 1} , {t}_{k 2} , … , {t}_{k {L}_{k}} \} \neq ∅ \qquad [ Formula 2 ]$$

$$t ∈ \{ {t}_{j 1} , {t}_{j 2} , … , {t}_{j {L}_{j}} , \} ⋂ \{ {t}_{k 1} , {t}_{k 2} , … , {t}_{k {L}_{k}} \} \qquad [ Formula 3 ]$$

Further, an example of the degree of overlap is the average value of the aforementioned IoU across all the frames in which Trajₜ and Trajₖ overlap.
2. The pair of Trajⱼ and Trajₖ are integrated and a single trajectory Traⱼ is created. When an object of a certain frame t is contained in both Traⱼ; and Trajₖ, the one with a higher reliability level is adopted. In a frame where there is no detected overlap, the object contained in the original trajectory Trajⱼ or Trajₖ is adopted.
3. Formula 4 is obtained.

$$𝒯 ← 𝒯 ⋃ \{ {Traj}_{l} \} ∖ \{ {Traj}_{j} , {Traj}_{k} \} \qquad [ Formula 4 ]$$

### Modified Example

Next, a modified example of the processing performed by the aforementioned information processing apparatus will be described. Although tracking is considered as an optimization problem on a graph where a node N on the graph is a detected object in the above, a detected object corresponding to a node N may be a trajectory piece of the object. Here, a trajectory piece is defined as a short piece of a trajectory including the same object. That is to say, in the processing performed by the abovementioned information processing apparatus, an object detected from a frame image may be defined as a short piece of the trajectory of the object. A trajectory piece can be generated using another tracker or the technique described hereinabove. Consequently, as a result of detection of a trajectory piece, there is a time width in addition to coordinates and time, so that it is possible to calculate a feature value of movement such as velocity. Accordingly, the graph constructing unit 3 and the value calculating unit 4 can also use a criterion based on the feature value of movement. The reliability level of detection of the trajectory piece can be a confidence level that the detection result is the trajectory piece, and the maximum value or average value of the reliability level that is the detection result can be employed.

The reliability level addition calculating unit 5 and the trajectory selecting unit 9 differ only in that a node N to be considered changes from an object to a trajectory piece, and the operation of calculating the value of an edge E from the reliability levels of both the nodes N remains the same. Additionally, by joining the trajectory pieces, the trajectory joining unit 10 and the overlapping trajectory integrating unit 11 can generate an object trajectory in the same manner as described above.

Thus, the information processing apparatus of the present disclosure concatenates the objects detected from the respective frames, calculates the value of the degree of concatenation based on the reliability level between the objects, and generates an object trajectory based on the value of the concatenation. Therefore, even in the case of a change in the shooting environment, such as image disturbances or an object being occluded by another object, it is possible to track the object with higher accuracy, thereby achieving increase of the tracking accuracy. Furthermore, since it is determined whether to discard based on the reliability level of object detection after setting a graph representing object tracking, it is possible to suppress decrease of a threshold value for a reliability level used as a criterion for graph construction or selection as trajectory, thereby suppressing excessive detection and tracking.

### Second Example Embodiment

Next, a second example embodiment of the present disclosure will be described with reference to the drawings. This example embodiment shows the overview of the information processing apparatus and so forth described in the above example embodiment. The drawings may be related to any of the example embodiments.

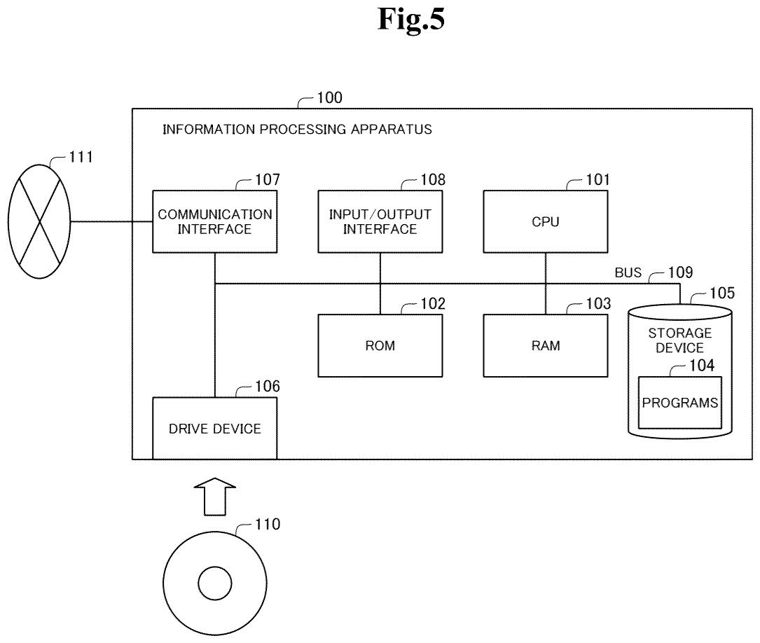

First, a hardware configuration of an information processing apparatus 100 in the present disclosure will be described. The information processing apparatus 100 is configured with a general information processing apparatus and, as an example, has the following hardware configuration as shown in FIG. 5, including:
a CPU (Central Processing Unit) 101 (arithmetic logic unit);
a ROM (Read Only Memory) 102 (memory unit);
a RAM (Random Access Memory) 103 (memory unit);
programs 104 loaded into the RAM 103;
a storage device 105 storing the programs 104;
a drive device 106 that performs reading from and writing into a storage medium 110 external to the information processing apparatus;
a communication interface 107 connected to a communication network 111 external to the information processing apparatus;
an input/output interface 108 that performs input/output of data; and
a bus 109 connecting the components.

FIG. 5 shows an example of the hardware configuration of the information processing apparatus serving as the information processing apparatus 100, and the hardware configuration of the information processing apparatus is not limited to the abovementioned case. For example, the information processing apparatus may be configured with part of the abovementioned configuration, such as not having the drive device 106. Moreover, the information processing apparatus may use a GPU (Graphic Processing Unit), a DSP (Digital Signal Processor), an MPU (Micro Processing Unit), an FPU (Floating point number Processing Unit), a PPU (Physics Processing Unit), a TPU (Tensor Processing Unit), a quantum processor, a microcontroller, or a combination thereof, instead of the abovementioned CPU.

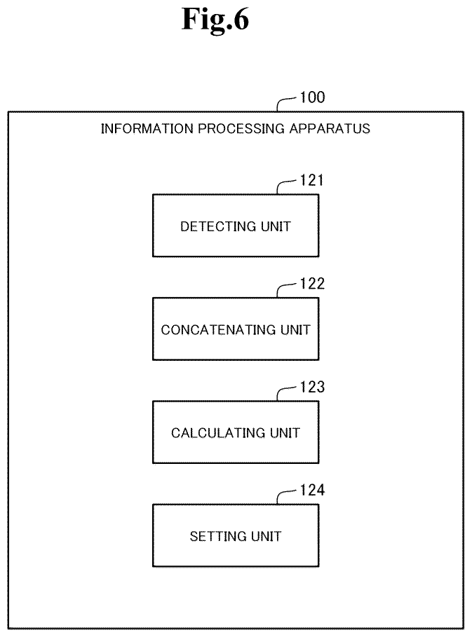

Then, by acquisition and execution of the programs 104 by the CPU 101, the information processing apparatus 100 can construct and include a detecting unit 121, a concatenating unit 122, a calculating unit 123, and a setting unit 124 shown in FIG. 6. The programs 104 are, for example, stored in advance in the storage device 105 or the ROM 102, and are loaded into the RAM 103 and executed by the CPU 101 as necessary. In addition, the programs 104 may be provided to the CPU 101 via the communication network 111, or the programs may be stored in advance in the storage medium 110 and read out by the drive device 106 and provided to the CPU 101. However, the aforementioned detecting unit 121, concatenating unit 122, calculating unit 123, and setting unit 124 may also be constructed using dedicated electronic circuits for realizing such means.

The detecting unit 121 detects an object from an image captured at each time and calculates the reliability level of the detected object. The concatenating unit 122 sets concatenation information that concatenates the objects detected at the respective times. The calculating unit 123 calculates the value of the concatenation information based on the reliability levels of the objects concatenated by the concatenation information. The setting unit 124 determines whether to adopt or reject the concatenation information that concatenates the objects based on the value of the concatenation information, and sets the concatenation of the objects by the adopted concatenation information as the trajectory of the objects.

Configured as described above, the present disclosure concatenates objects detected from images and calculates the value of the concatenation based on the reliability level between the objects, thereby generating an object trajectory based on the value of the concatenation. Therefore, even in the case of a change in the shooting environment, such as image disturbances or an object being occluded by another object, it is possible to track the object with higher accuracy, thereby achieving improvement of the tracking accuracy.

It should be noted that at least one of the functions of the detecting unit 121, concatenating unit 122, calculating unit 123, and setting unit 124 described above may be executed by an information processing apparatus installed and connected at any location on a network; in other words, it may also be executed by so-called cloud computing.

Further, the abovementioned programs can be stored using various types of non-transitory computer-readable mediums and provided to a computer. The non-transitory computer-readable medium includes various types of tangible storage mediums. Examples of non-transitory computer-readable medium include magnetic recording medium (e.g., flexible disk, magnetic tape, hard disk drive), magneto-optical recording medium (e.g., magneto-optical disk), read only memory (CD-ROM), CD-R, CD-R/W, semiconductor memory (e.g., mask ROM, programmable ROM, Erasable PROM, flash ROM, random access memory (RAM)). In addition, a program may be provided to a computer by various types of temporary computer-readable medium. Examples of temporary computer-readable medium include electrical signals, optical signals, and electromagnetic waves. The temporary computer-readable medium may provide a program to the computer via a wired communication channel, such as an electric wire and an optical fiber, or a wireless communication channel.

Although the present disclosure has been described above with reference to example embodiments, the present disclosure is not limited to the example embodiments described above. The configuration and details of the present disclosure can be changed in a variety of ways that those skilled in the art can understand within the scope of the present disclosure. Then, each of the example embodiments described above can be combined with the other example embodiment as necessary.

### <Supplementary Notes>

The whole or part of the example embodiments disclosed above can be described as the following supplementary notes. Hereinafter, the overview of the configurations of an information processing apparatus, an information processing method, and a program in the present disclosure will be described. However, the present disclosure is not limited to the configurations described in the following supplementary notes.

All or some of the configurations described in Supplementary Notes 2 to 8 dependent on Supplementary Note 1 below and the functions by such configurations may also be dependent on other Supplementary Notes 9 and 10 by the same dependence as Supplementary Notes 2 to 8. Furthermore, not limited to Supplementary Notes 1, 9 and 10, within the scope of the example embodiments described above, all or some of the configurations described as supplementary notes and functions by such configurations may be dependent on hardware, software, various recording means for recording software, or system.

### (Supplementary Note 1)

An information processing apparatus comprising:
at least one memory storing processing instructions; and
at least one processor configured to execute the processing instructions to:
detect objects from images of respective times, and calculate reliability levels of the detected objects;
set concatenation information that concatenates between the objects detected for the respective times;
calculate a value of the concatenation information in accordance with the reliability levels of the objects concatenated by the concatenation information; and
determine whether to adopt or reject the concatenation information that concatenates between the objects in accordance with the value of the concatenation information, and set the concatenation between the objects by the adopted concatenation information, as an object trajectory.

### (Supplementary Note 2)

The information processing apparatus according to supplementary note 1, wherein the at least one processor is configured to execute the processing instructions to:
calculate the value of the concatenation information to be higher as the reliability levels of the objects concatenated on the concatenation information is higher; and
determine to adopt the concatenation information preferentially as the value of the concatenation information is higher.

### (Supplementary Note 3)

The information processing apparatus according to supplementary note 1, wherein the at least one processor is configured to execute the processing instructions to calculate the value of the concatenation information in accordance with the reliability level of each of two objects concatenated on the concatenation information.

### (Supplementary Note 4)

The information processing apparatus according to supplementary note 1, wherein the at least one processor is configured to execute the processing instructions to calculate the value of the concatenation information in accordance with the reliability level of one of two objects concatenated on the concatenation information.

### (Supplementary Note 5)

The information processing apparatus according to supplementary note 1, wherein the at least one processor is configured to execute the processing instructions to in accordance with the reliability level of each of two objects concatenated on the concatenation information, discard the concatenation between the objects by the adopted concatenation information without setting as the object trajectory.

### (Supplementary Note 6)

The information processing apparatus according to supplementary note 5, wherein the at least one processor is configured to execute the processing instructions to in a case where a value based on the reliability level of each of the two objects concatenated on the concatenation information is lower than a preset reference value, discard the concatenation between the objects by the adopted concatenation information without setting as the object trajectory.

### (Supplementary Note 7)

The information processing apparatus according to supplementary note 1, wherein the at least one processor is configured to execute the processing instructions to generate a joined trajectory obtained by joining a plurality of the trajectories, and with respect to a part where the object trajectories coexist at same time in a plurality of the joined trajectories, adopt the part in one of the joined trajectories and discard the part in the other of the joined trajectories, thereby further connecting and joining a plurality of the joined trajectories.

### (Supplementary Note 8)

The information processing apparatus according to supplementary note 7, wherein the at least one processor is configured to execute the processing instructions to in the part where the object trajectories coexist at the same time in a plurality of the joined trajectories, adopt the part in the joined trajectory with the reliability level of the object being higher and discard the part in the joined trajectory with the reliability level of the object being lower, thereby further connecting and joining a plurality of the object trajectories.

### (Supplementary Note 9)

An information processing method comprising:
detecting objects from images of respective times, and calculating reliability levels of the detected objects;
setting concatenation information that concatenates between the objects detected for the respective times;
calculating a value of the concatenation information in accordance with the reliability levels of the objects concatenated by the concatenation information; and
determining whether to adopt or reject the concatenation information that concatenates between the objects in accordance with the value of the concatenation information, and setting the concatenation between the objects by the adopted concatenation information, as an object trajectory.

### (Supplementary Note 9.1)

The information processing method according to supplementary note 9, further comprising
generating a joined trajectory obtained by joining a plurality of the trajectories, and with respect to a part where the object trajectories coexist at same time in a plurality of the joined trajectories, adopting the part in one of the joined trajectories and discarding the part in the other of the joined trajectories, thereby further connecting and joining a plurality of the joined trajectories.

### (Supplementary Note 10)

A program comprising instructions for causing an information processing apparatus to detect objects from images of respective times, and calculate reliability levels of the detected objects; set concatenation information that concatenates between the objects detected for the respective times; calculate a value of the concatenation information in accordance with the reliability levels of the objects concatenated by the concatenation information; and determine whether to adopt or reject the concatenation information that concatenates between the objects in accordance with the value of the concatenation information, and set the concatenation between the objects by the adopted concatenation information, as an object trajectory.

### REFERENCE SIGNS LIST

1 video providing unit
2 object detecting unit
3 graph constructing unit
4 value calculating unit
5 reliability level addition calculating unit
6 constraint condition enumerating unit
7 optimizing unit
8 concatenated part enumerating unit
9 trajectory selecting unit
10 trajectory joining unit
11 overlapping trajectory integrating unit
100 information processing apparatus
101 CPU
102 ROM
103 RAM
104 programs
105 storage device
106 drive device
107 communication interface
108 input/output interface
109 bus
110 storage medium
111 communication network
121 detecting unit
122 concatenating unit
123 calculating unit
124 setting unit

1. An information processing apparatus comprising:
at least one memory storing processing instructions; and
at least one processor configured to execute the processing instructions to:
detect objects from images of respective times, and calculate reliability levels of the detected objects;
set concatenation information that concatenates between the objects detected for the respective times;
calculate a value of the concatenation information in accordance with the reliability levels of the objects concatenated by the concatenation information; and
determine whether to adopt or reject the concatenation information that concatenates between the objects in accordance with the value of the concatenation information, and set the concatenation between the objects by the adopted concatenation information, as an object trajectory.

2. The information processing apparatus according to claim 1, wherein the at least one processor is configured to execute the processing instructions to:
calculate the value of the concatenation information to be higher as the reliability levels of the objects concatenated on the concatenation information is higher; and
determine to adopt the concatenation information preferentially as the value of the concatenation information is higher.

3. The information processing apparatus according to claim 1, wherein the at least one processor is configured to execute the processing instructions to
calculate the value of the concatenation information in accordance with the reliability level of each of two objects concatenated on the concatenation information.

4. The information processing apparatus according to claim 1, wherein the at least one processor is configured to execute the processing instructions to
calculate the value of the concatenation information in accordance with the reliability level of one of two objects concatenated on the concatenation information.

5. The information processing apparatus according to claim 1, wherein the at least one processor is configured to execute the processing instructions to
in accordance with the reliability level of each of two objects concatenated on the concatenation information, discard the concatenation between the objects by the adopted concatenation information without setting as the object trajectory.

6. The information processing apparatus according to claim 5, wherein the at least one processor is configured to execute the processing instructions to
in a case where a value based on the reliability level of each of the two objects concatenated on the concatenation information is lower than a preset reference value, discard the concatenation between the objects by the adopted concatenation information without setting as the object trajectory.

7. The information processing apparatus according to claim 1, wherein the at least one processor is configured to execute the processing instructions to
generate a joined trajectory obtained by joining a plurality of the trajectories, and with respect to a part where the object trajectories coexist at same time in a plurality of the joined trajectories, adopt the part in one of the joined trajectories and discard the part in the other of the joined trajectories, thereby further connecting and joining a plurality of the joined trajectories.

8. The information processing apparatus according to claim 7, wherein the at least one processor is configured to execute the processing instructions to
in the part where the object trajectories coexist at the same time in a plurality of the joined trajectories, adopt the part in the joined trajectory with the reliability level of the object being higher and discard the part in the joined trajectory with the reliability level of the object being lower, thereby further connecting and joining a plurality of the object trajectories.

9. An information processing method comprising:
detecting objects from images of respective times, and calculating reliability levels of the detected objects;
setting concatenation information that concatenates between the objects detected for the respective times;
calculating a value of the concatenation information in accordance with the reliability levels of the objects concatenated by the concatenation information; and
determining whether to adopt or reject the concatenation information that concatenates between the objects in accordance with the value of the concatenation information, and setting the concatenation between the objects by the adopted concatenation information, as an object trajectory.

10. The information processing method according to claim 9, further comprising:
calculating the value of the concatenation information to be higher as the reliability levels of the objects concatenated on the concatenation information is higher; and
determining to adopt the concatenation information preferentially as the value of the concatenation information is higher.

11. The information processing method according to claim 9, further comprising
calculating the value of the concatenation information in accordance with the reliability level of each of two objects concatenated on the concatenation information.

12. The information processing method according to claim 9, further comprising
calculating the value of the concatenation information in accordance with the reliability level of one of two objects concatenated on the concatenation information.

13. The information processing method according to claim 9, further comprising
in accordance with the reliability level of each of two objects concatenated on the concatenation information, discarding the concatenation between the objects by the adopted concatenation information without setting as the object trajectory.

14. The information processing method according to claim 9, further comprising
generating a joined trajectory obtained by joining a plurality of the trajectories, and with respect to a part where the object trajectories coexist at same time in a plurality of the joined trajectories, adopting the part in one of the joined trajectories and discarding the part in the other of the joined trajectories, thereby further connecting and joining a plurality of the joined trajectories.

15. A non-transitory computer-readable storage medium storing a program, the program comprising instructions for causing an information processing apparatus to detect objects from images of respective times, and calculate reliability levels of the detected objects; set concatenation information that concatenates between the objects detected for the respective times; calculate a value of the concatenation information in accordance with the reliability levels of the objects concatenated by the concatenation information; and determine whether to adopt or reject the concatenation information that concatenates between the objects in accordance with the value of the concatenation information, and set the concatenation between the objects by the adopted concatenation information, as an object trajectory.
